(19) United States
(12) Patent Application Publication
(10) Pub. No.: US 2012/0327415 A1
(43) Pub. Date: Dec. 27, 2012

(54) DEFECT INSPECTION APPARATUS AND DEFECT INSPECTION METHOD

(75) Inventor: Masaaki Ito, Hitachinaka (JP)

(73) Assignee: HITACHI HIGH-TECHNOLOGIES CORPORATION, Tokyo (JP)

(21) Appl. No.: 13/515,762

(22) PCT Filed: Nov. 4, 2010
(86) PCT No.: PCT/JP2010/006479

§ 371 Date: Aug. 22, 2012

(30) Foreign Application Priority Data
Dec. 14, 2009 (JP) 2009-282363

(51) Int. Cl. G01N 21/88

(52) U.S. Cl. 356/369

(57) ABSTRACT

The present invention provides a defect inspection apparatus having high sensitivity and high throughput capabilities in defect inspection of a sample on which a pattern is formed, such as a semiconductor wafer.

One feature of the present invention is that a direction of a pattern, directions in which illumination light beams are projected on a sample, and polarization of the illumination light beams are paid attention to. Another feature of the present invention is that projections on the sample in at least two illumination directions are perpendicular to or in parallel with a direction of the main pattern of the sample, and that the polarization of the illumination light beam in the first direction differs from the polarization of the illumination light beam in the second direction. Still another feature of the present invention is that the projection in the first direction and the projection in the second direction are perpendicular to each other. A further feature of the present invention is that the projection in the first direction and the projection in the second direction are in parallel with each other. Still a further feature of the present invention is that the polarization of the illumination light beam in the first direction is s-polarization, whereas the polarization of the illumination light beam in the second direction is p-polarization.

### TECHNICAL FIELD

The present invention relates to an apparatus for and a method of inspecting a defect on a sample such as a wafer in the production of semiconductor devices, wherein the sample is formed with a pattern. More particularly, the invention relates to an optical system in an optical defect inspection apparatus.

### BACKGROUND ART

Film formation by sputtering and chemical vapor deposition, planarization by chemical mechanical polishing, and patterning by lithography and etching are repeated many times in a process for manufacturing semiconductor devices. In order to ensure the yields of semiconductor devices, wafers are extracted and inspected for defects in the course of the manufacturing process. Examples of defects include a foreign matter, a swelling, a void, a scratch on the surface of a wafer, and pattern defects (a short circuit, an open circuit, a hole-opening failure, and the like). The defect inspection first aims to manage under what condition the manufacturing apparatus is, and, second, to identify the process at which a failure has occurred and its associated cause. With the progress in miniaturization of semiconductor devices, defect inspection apparatuses are required to have high detection sensitivity.

Several hundreds of devices (referred to as “chips”), each of which has the same pattern, are formed on a wafer. In addition, a large number of cells having repeated patterns are formed on a memory section provided in a device. Defect inspection apparatuses use a method of comparing images between adjacent chips or between adjacent cells.

Dark-field defect inspection apparatuses irradiate a wafer with light beams to compare dark-field images. Since such a dark-field defect inspection apparatus has higher throughput than other types of defect inspection apparatuses, it is frequently used for in-line inspection.

JP-2005-156537-A (Patent Document 1) discloses a dark-field defect inspection apparatus, wherein a wafer is irradiated with illumination light beams from a plurality of directions to detect scattered light beams from the wafer on a direction basis. Incident angles of the illumination light beams differ depending on the illumination directions whereas wavelengths of the illumination light beams are the same or differ from one another.

In addition, JP-2007-225432-A (Patent Document 2) discloses a dark-field defect inspection apparatus, wherein a wafer is irradiated with illumination light beams from a plurality of directions to detect scattered light beams from the wafer on a direction basis. Polarization of the illumination light beams differs for each illumination direction.

### PRIOR ART LITERATURE

### Patent Documents

Patent Document 1: JP-2005-156537-A

Patent Document 2: JP-2007-225432-A

### SUMMARY OF THE INVENTION

### Problems to be Solved by the Invention

With the progress in miniaturization of semiconductor devices, optical defect inspection apparatuses are required to improve detection sensitivity. In particular, at the time of inspection after patterning of gates, bit lines and the like, it is necessary to detect a short circuit and an open circuit which are very minute. Thus, ensuring the signal intensity is required.

Patent Document 1 discloses a technique in which images from a plurality of directions are handled in an integrated manner to reduce speckle noises from pattern edges. However, the signal intensity is not taken into consideration.

Patent Document 2 discloses a technique in which illumination light beams, each of which is subjected to different polarization, are used to stabilize the signal intensity against fluctuations in the thickness of an oxide film. However, targeted defects are foreign matters, and pattern defects are not taken into consideration.

An object of the present invention is to provide a defect inspection apparatus which has high sensitivity and high throughput capabilities for, in particular, pattern defects.

### Means for Solving the Problems

In order to achieve the above-described object, the present invention has the feature, wherein a direction of a pattern, directions in which illumination light beams are projected on a sample, and polarization of the illumination light beams are paid attention to.

In addition, according to one aspect of the present invention, there is provided a defect inspection apparatus which irradiates a sample, on which a pattern is formed, with illumination light beams from a plurality of directions, and forms an image of the sample in an image sensor through an optical system to determine whether or not a defect exists therein. Projections on the sample in at least two illumination directions are perpendicular to or in parallel with a direction of the main pattern of the sample. Polarization of the illumination light beam in the first direction differs from polarization of the illumination light beam in the second direction.

In addition, according to the present invention, the projection in the first direction and the projection in the second direction are perpendicular to each other.

In addition, according to the present invention, the projection in the first direction and the projection in the second direction are in parallel with each other.

In addition, according to the present invention, polarization of the illumination light beam in the first direction is s-polarization, whereas polarization of the illumination light beam in the second direction is p-polarization.

In addition, according to the present invention, the optical system is a dark-field type optical system.

In addition, according to the present invention, the optical system is a bright-field type optical system.

In addition, according to the present invention, the illumination light beam in the first direction and the illumination light beam in the second direction are spatially incoherent.

In addition, according to the present invention, the illumination light beam in the first direction and the illumination light beam in the second direction are spatially coherent.

Moreover, according to another aspect of the present invention, there is provided a defect inspection apparatus which irradiates a sample, on which a pattern is formed, with illumination light beams from a plurality of directions, and forms an image of the sample in an image sensor through an optical system to determine whether or not a defect exists therein. Projections on the sample in at least two illumination directions are perpendicular to or in parallel with a direction of the main pattern of the sample. A wavelength of the illumination light beam in the first direction differs from a wavelength of the illumination light beam in the second direction. Polarization of the illumination light beam in the first direction differs from polarization of the illumination light beam in the second direction.

In addition, according to the present invention, the projection in the first direction and the projection in the second direction are perpendicular to each other.

In addition, according to the present invention, the projection in the first direction and the projection in the second direction are in parallel with each other.

In addition, according to the present invention, polarization of the illumination light beam in the first direction is s-polarization, whereas polarization of the illumination light beam in the second direction is p-polarization.

In addition, according to the present invention, the optical system is a dark-field type optical system.

In addition, according to the present invention, the optical system is a bright-field type optical system.

In addition, according to the present invention, the illumination light beam in the first direction and the illumination light beam in the second direction are spatially incoherent.

In addition, according to the present invention, the illumination light beam in the first direction and the illumination light beam in the second direction are spatially coherent.

### Effects of the Invention

According to the present invention, the illumination method which is suitable for detecting a short circuit, an open circuit and the like enables defect inspection with high sensitivity and high throughput.

### BRIEF DESCRIPTION OF THE DRAWINGS

FIG. 1 is a diagram illustrating a first embodiment of a defect inspection apparatus according to the present invention;

FIG. 2 is a diagram illustrating the relationship between a pattern on a wafer and illumination light beams;

FIG. 3 is a diagram illustrating the relationship between illumination conditions and the signal intensity corresponding to a short circuit;

FIG. 4 is a diagram illustrating two-directional illumination applied to a short circuit;

FIG. 5 is a diagram illustrating four-directional illumination applied to a short circuit;

FIG. 6 is a diagram illustrating the relationship between illumination conditions and the signal intensity corresponding to an open circuit;

FIG. 7 is a diagram illustrating two-directional illumination applied to a short circuit and an open circuit;

FIG. 8 is a diagram illustrating another two-directional illumination applied to a short circuit and an open circuit;

FIG. 9 is a flowchart illustrating the flow of setting illumination conditions;

FIG. 10 is a diagram illustrating an operation screen for setting illumination conditions;

FIG. 11 is a diagram illustrating a second embodiment of a defect inspection apparatus according to the present invention;

FIG. 12 is a diagram illustrating two-directional illumination applied to a short circuit in the second embodiment; and

FIG. 13 is a diagram illustrating the relationship between the thickness of an oxide film and the signal intensity corresponding to a short circuit.

### MODES FOR CARRYING OUT THE INVENTION

As one embodiment of the present invention, a dark-field defect inspection apparatus targeted for semiconductor wafers will be described.

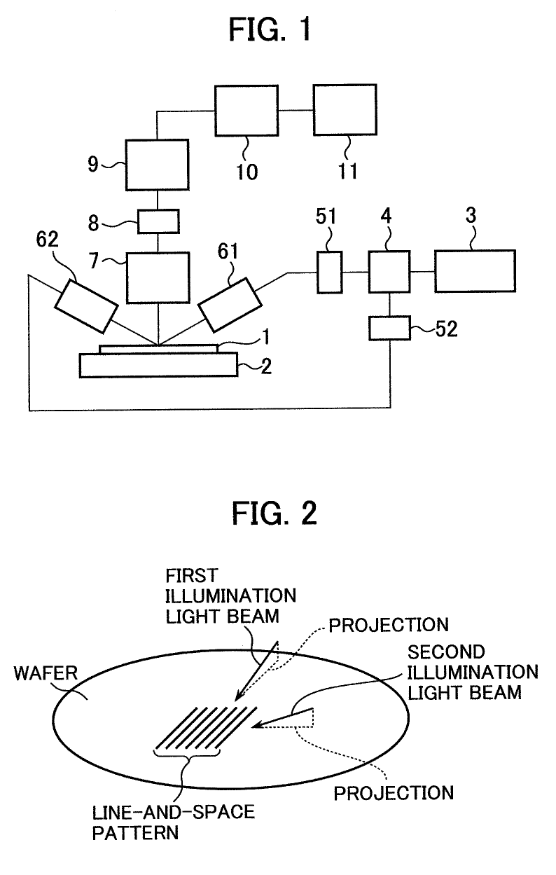

FIG. 1 is a diagram schematically illustrating a configuration of the inspection apparatus. The inspection apparatus is provided with a stage 2 on which a wafer 1 is placed, a light source 3, a branch element 4, a first polarizing element 51, a second polarizing element 52, a first illumination optical system 61, a second illumination optical system 62, a detection optical system 7, a detector 8, an image processing unit 9, an overall control unit 10 and an input/output operation unit 11.

When the wafer 1 is placed on the defect inspection apparatus, an operator inputs information including a pattern layout and a kind of defect of interest into the input/output operation unit 11. The overall control unit 10 uses the information to select a suitable illumination method as described below.

A light beam emitted from the light source 3 is divided into two optical paths by the branch element 4. The polarizing elements 51, 52 cause respective light beams to change into two linear polarized light beams which are orthogonal to each other, and with which the wafer 1 is irradiated through the illumination optical systems 61, 62 respectively. There is provided a difference in optical path length between the first and second illumination light beams, and therefore the first and second illumination light beams are spatially incoherent. Directions of the first and second illumination light beams are set in such a manner that projections on the wafer surface become perpendicular to each other. Here, the projections mean wafer in-plane components of direction vectors of the illumination light beams. The projections are perpendicular to or parallel with a main pattern of the wafer. In addition, with respect to the wafer, the first illumination light beam is s-polarization, and the second illumination light beam is p-polarization. The light beams scattered by the wafer are collected by the detection optical system 7. A regular reflected light beam from the wafer is emitted to the outside of the aperture of the detection optical system, and therefore a dark field image is formed in the detector 8. An inspection image is converted into a digital signal by an A/D converter (not illustrated), and the digital signal is then recorded in the image processing unit 9. A reference image obtained by a chip is recorded in the image processing unit. In this case, the chip is adjacent to an inspection chip, and has the identical pattern. The inspection image and the reference image are subjected to processing such as alignment, and a difference image therebetween is then output. The brightness of this difference image is compared with a predetermined threshold value to determine whether or not a defect exists therein. The result of the defect determination is transmitted to the overall control unit, and is then displayed on the input/output operation unit after the predetermined inspection ends.

FIG. 2 is a diagram illustrating the relationship between a pattern and an illumination light beam in the above-mentioned embodiment. The wafer is formed with a line-and-space pattern, and is irradiated with illumination light beams from two directions. A projection on the wafer from the first direction is perpendicular to the pattern-pitch direction. A projection on the wafer from the second direction is in parallel with the pattern-pitch direction. Thus, the projections in the first and second directions are perpendicular to each other. In addition, with respect to polarization, the illumination light beam in the first direction is s-polarization, whereas the illumination light beam in the second direction is p-polarization.

In the present invention, the directions and polarizations of the illumination light beams are set according to the pattern and a defect of interest. The details will be described as below.

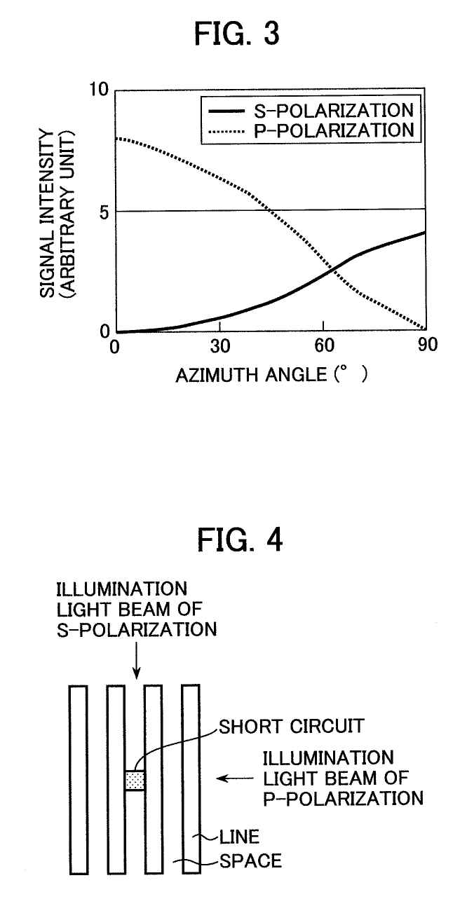

When a pattern defect is inspected, it is particularly important to detect a short circuit that is a critical defect. FIG. 3 is a diagram illustrating the relationship between an azimuth angle of an illumination light beam and the signal intensity corresponding to a short circuit of the line-and-space pattern. Here, the azimuth angle is defined by an angle formed by a projection on the wafer in the illumination direction and the pattern-pitch direction. It is understood that the signal intensity depends on the polarization and the azimuth angle. In the case of s-polarization, the signal intensity corresponding to the short circuit becomes the highest at an azimuth angle of 90°. In the case of p-polarization, the signal intensity corresponding to the short circuit becomes the highest at an azimuth angle of 0°. In any case, the projections of electric field vectors of the illumination light beams on the wafer are in parallel with the pattern-pitch direction. Meanwhile, in the case of s-polarization, the signal intensity corresponding to the short circuit becomes 0 at an azimuth angle of 0°. In the case of p-polarization, the signal intensity corresponding to the short circuit becomes 0 at an azimuth angle of 90°.

Incidentally, when the wafer is irradiated with an illumination light beam from one direction, speckles are easily caused by grain on the surface of the wafer, and by the roughness of line edges. This often hinders the detection of a defect. In order to reduce such noises, it is effective to irradiate the wafer with illumination light beams from a plurality of directions to decrease the spatial coherence.

In consideration of the above, FIG. 4 illustrates an illumination method which is suitable for irradiating a wafer with illumination light beams from two directions to detect a pattern short circuit. The wafer is irradiated with an illumination light beam of s-polarization from a direction perpendicular to the pattern-pitch direction; and the wafer is irradiated with an illumination light beam of p-polarization from a direction that is in parallel with the pattern-pitch direction. Such two-directional illumination makes it possible to reduce noises, and to ensure the signal intensity corresponding to a short circuit.

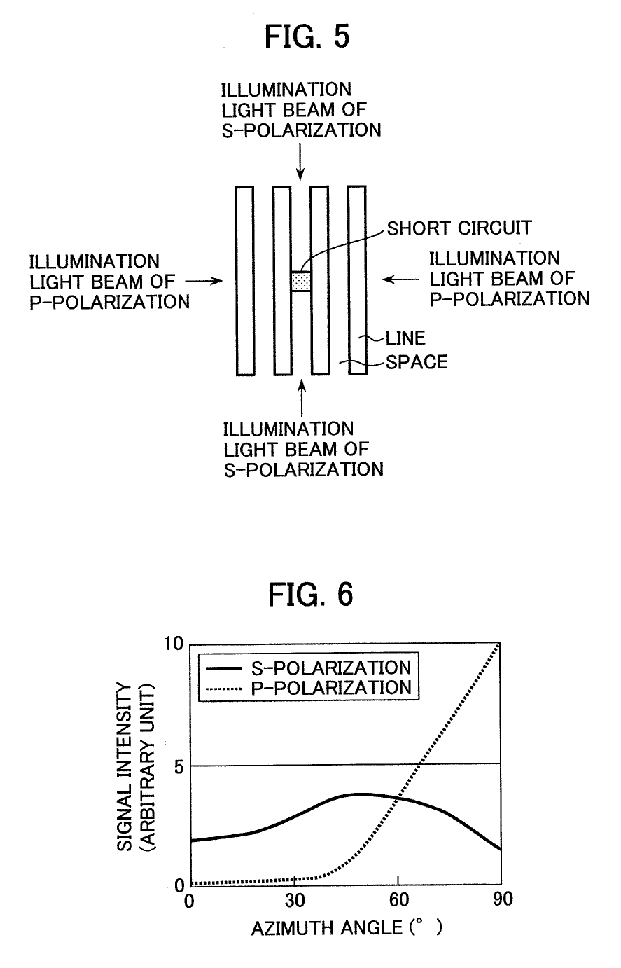

In addition, FIG. 5 is a diagram illustrating an illumination method which is suitable for irradiating a wafer with illumination light beams from four directions to detect a pattern short circuit. The wafer is irradiated with illumination light beams of s-polarization from two directions perpendicular to the pattern-pitch direction; and the wafer is irradiated with illumination light beams of p-polarization from two directions that are in parallel with the pattern-pitch direction. In comparison with the two-directional illumination, four-directional illumination makes the illumination optical system more complicated. However, the four-directional illumination enables further noise reduction.

In addition, when a pattern defect is inspected, it is also important to detect an open circuit that is a critical defect. FIG. 6 is a diagram illustrating the relationship between an azimuth angle of an illumination light beam and the signal intensity corresponding to an open circuit of a line-and-space pattern. In the case of p-polarization, the signal intensity corresponding to the open circuit becomes the highest at an azimuth angle of 90°. However, under this condition, the signal intensity of a short circuit becomes 0 as shown in FIG. 3.

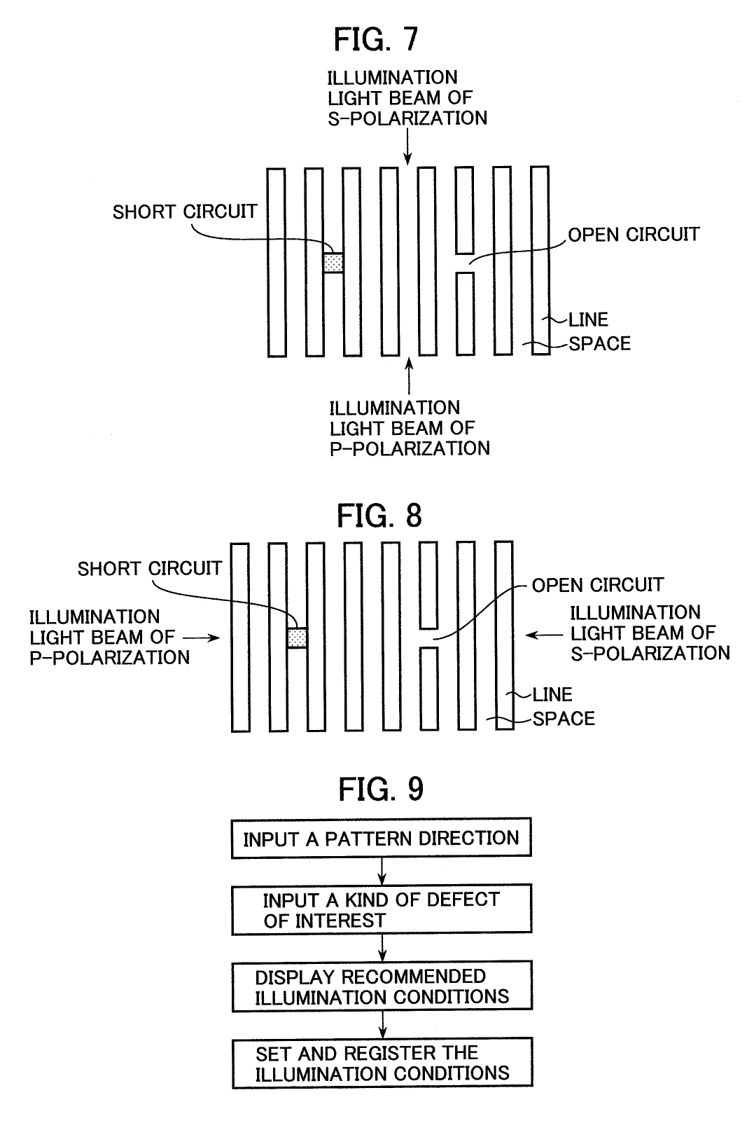

Accordingly, FIG. 7 illustrates an illumination method which is suitable for detecting both a short circuit and an open circuit on a wafer having the short circuit and the open circuit. The wafer is irradiated with illumination light beams from two directions perpendicular to the pattern-pitch direction. The first illumination light beam is s-polarization; and the second illumination light beam is p-polarization. Such two-directional illumination makes it possible to detect a short circuit by use of the first illumination light beam, and to detect an open circuit by use of the second illumination light beam.

Moreover, FIG. 8 is a diagram illustrating another illumination method which is suitable for detecting both a short circuit and an open circuit. The wafer is irradiated with illumination light beams from two directions in parallel with the pattern-pitch direction. The first illumination light beam is s-polarization; and the second illumination light beam is p-polarization. Such two-directional illumination makes it possible to detect an open circuit by use of the first illumination light beam, and to detect a short circuit by use of the second illumination light beam.

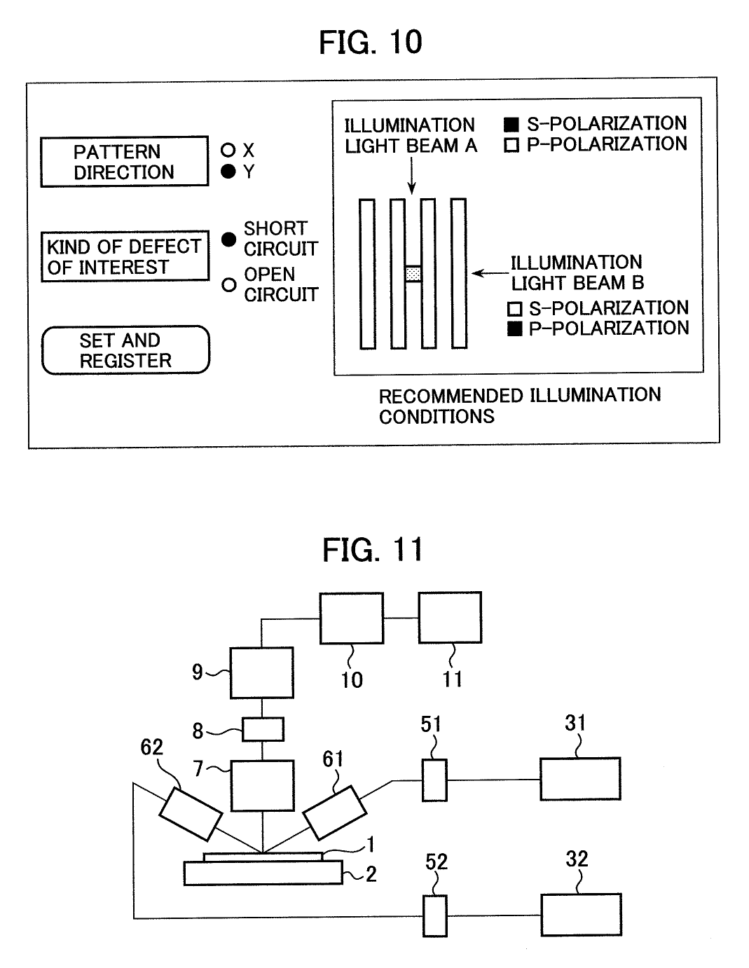

FIG. 9 is a flow chart illustrating how to set the above-described illumination conditions by a user. First of all, the user uses the input/output operation unit to input a main direction of a pattern on the inspection apparatus. Next, the user inputs a kind of defect of interest. The overall control unit selects recommended illumination conditions on the basis of the above-described input information, and then displays the illumination conditions on an operation screen. The user checks the illumination conditions, and then sets and registers the illumination conditions in an inspection recipe. FIG. 10 is a diagram illustrating an operation screen in which a direction in which the pattern extends is a Y direction, a kind of defect of interest is a short circuit, and the number of directions of illumination light beams is two.

Next, how to inspect a pattern defect on an oxide film will be described. The oxide film is transparent, and therefore thin film interference occurs. The signal intensity greatly fluctuates depending on the thickness of the oxide film. In the case of a wafer in which irregularities in the film thickness are large, a method in which a wafer is irradiated with light beams each having a different wavelength is effective for reducing thin film interference effects.

A second embodiment of the present invention, which is suitable for inspecting a pattern defect on an oxide film, will be described with reference to FIG. 11. A light source 31 emits far-ultraviolet light; and a light source 32 emits ultraviolet light. A wafer is irradiated with the far-ultraviolet light by linear polarization through a first polarizing element 51 and a first illumination optical system 61. The wafer is irradiated with the ultraviolet light by linear polarization through a second polarizing element 52 and a second illumination optical system 62. Here, a direction of the far-ultraviolet light and that of the ultraviolet light are set in such a manner that projections on the wafer surface become perpendicular to each other. The projections are perpendicular to or in parallel with the main pattern of the wafer. In addition, the polarization of the far-ultraviolet light differs from that of the ultraviolet light. One is s-polarization, and the other is p-polarization. The far-ultraviolet light and the ultraviolet light, which have been scattered by the wafer, are collected by the detection optical system 7; and a dark field image is formed in the detector 8.

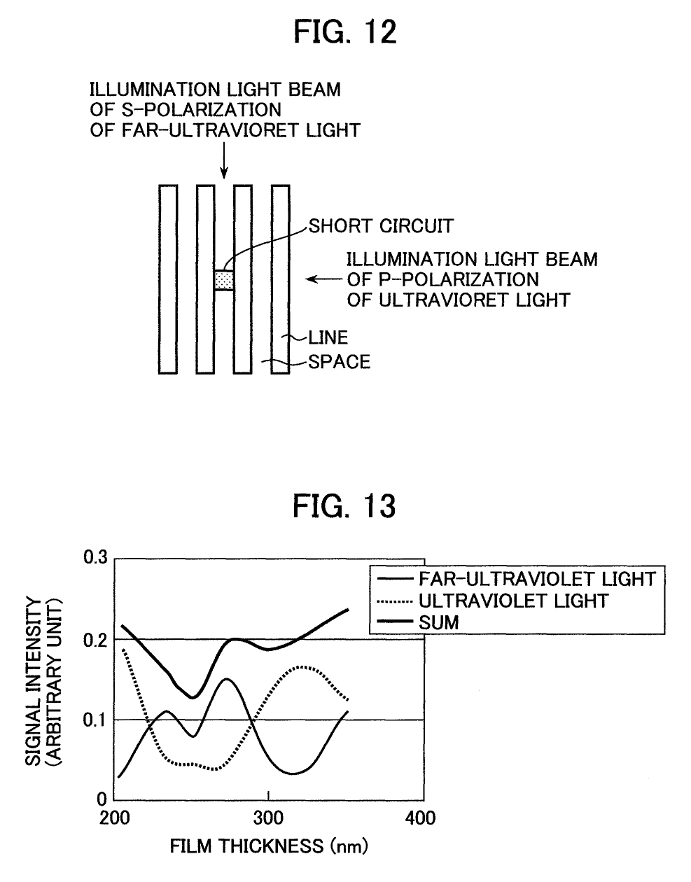

FIG. 12 is a diagram illustrating an illumination method which is suitable for detecting a short circuit of a pattern. A wafer is irradiated with a far-ultraviolet light beam of s-polarization from a direction perpendicular to the pattern-pitch direction. The wafer is irradiated with an ultraviolet light beam of p-polarization from a direction in parallel with the pattern-pitch direction.

FIG. 13 is a chart illustrating the relationship between the thickness of an oxide film and the signal intensity corresponding to a short circuit. It is understood that the signal intensity of the far-ultraviolet light beam and that of the ultraviolet light beam each greatly fluctuate with respect to the film thickness. Meanwhile, fluctuations in the sum of the signal intensity of the far-ultraviolet light and that of the ultraviolet light are small with respect to the film thickness. Thus, the two-directional illumination in which each of light beams has a different wavelength and uses different polarization makes it possible to ensure the signal intensity even in the case of a wafer in which there are irregularities in the film thickness.

In the embodiment described above, the illumination light beams are spatially incoherent. However, the illumination light beams can also be configured to be coherent by making the optical path lengths equal to each other. In the case of the coherent illumination, the interference effects may cause the signal intensity to further increase although noises increase. Accordingly, when the signal intensity is not sufficiently high while noises are sufficiently low, the coherent illumination is effective.

In addition, in the embodiment described above, the projection on the wafer in the illumination direction is perpendicular to or in parallel with the main direction of the pattern. However, even when the angle deviates to some extent, substantially the same effects can be achieved.

Moreover, in the embodiment described above, the polarization of the illumination light beams is s-polarization or p-polarization. However, even when the polarization deviates to some extent, substantially the same effects can be achieved.

Further, in the embodiment described above, an illumination region on the wafer can be configured to be slit-like. The slit-like illumination region enables high-throughput defect inspection when the wafer is scanned in the short-side direction.

Furthermore, in the embodiment described above, a plurality of detection systems may be provided. In many cases, the distribution of scattered light of a defect changes depending on the thickness of an oxide film. Accordingly, using an upward detection system and an oblique detection system in combination produces an effect of stabilizing the detection sensitivity against irregularities in the film thickness.

In addition, the above-described embodiment discloses the dark-field defect inspection apparatus for semiconductor wafers. However, the present invention can also be applied to a bright-field defect inspection apparatus.

Moreover, the present invention can also be applied to the inspection of a sample on which a minute pattern is formed, such as a mask of a semiconductor lithography process.

### DESCRIPTION OF REFERENCE NUMERALS

1 Wafer
2 Stage
3 Light source
4 Branch element
7 Detection optical system
8 Detector
9 Image processing unit
10 Overall control unit
11 Input/output operation unit
51 First polarizing element
52 Second polarizing element
61 First illumination optical system
62 Second illumination optical system

1. A defect inspection apparatus which irradiates a sample, on which a pattern is formed, with illumination light beams from a plurality of directions, and forms an image of the sample in an image sensor through an optical system to determine whether or not a defect exists therein, wherein:
the first projection of the illumination light beam in the first direction is substantially in parallel with the direction of the pattern, whereas the second projection of the second illumination light beam is substantially perpendicular to the direction of the pattern; and
polarization of the illumination light beam in the first direction differs from polarization of the illumination light beam in the second direction.

2. (canceled)

3. (canceled)

4. The defect inspection apparatus according to claim 1, wherein:
polarization of the illumination light beam in the first direction is s-polarization, whereas polarization of the illumination light beam in the second direction is p-polarization.

5. The defect inspection apparatus according to claim 1, wherein:
the optical system is a dark-field type optical system.

6. The defect inspection apparatus according to claim 1, wherein:
the optical system is a bright-field type optical system.

7. The defect inspection apparatus according to claim 1, wherein:
the illumination light beam in the first direction and the illumination light beam in the second direction are spatially incoherent.

8. The defect inspection apparatus according to claim 1, wherein:
the illumination light beam in the first direction and the illumination light beam in the second direction are spatially coherent.

9. A defect inspection apparatus which irradiates a sample, on which a pattern is formed, with illumination light beams from a plurality of directions, and forms an image of the sample in an image sensor through an optical system to determine whether or not a defect exists therein, wherein:
the first projection of the illumination light beam in the first direction is substantially in parallel with the direction of the pattern, whereas the second projection of the second illumination light beam is substantially perpendicular to the direction of the pattern;
a wavelength of the illumination light beam in the first direction differs from a wavelength of the illumination light beam in the second direction; and
polarization of the illumination light beam in the first direction differs from polarization of the illumination light beam in the second direction.

10. (canceled)

11. (canceled)

12. The defect inspection apparatus according to claim 9, wherein:
polarization of the illumination light beam in the first direction is s-polarization, whereas polarization of the illumination light beam in the second direction is p-polarization.

13. The defect inspection apparatus according to claim 9, wherein:
the optical system is a dark-field type optical system.

14. The defect inspection apparatus according to claim 9, wherein:
the optical system is a bright-field type optical system.

15. The defect inspection apparatus according to claim 9, wherein:
the illumination light beam in the first direction and the second illumination light beam are spatially incoherent.

16. The defect inspection apparatus according to claim 9, wherein:
the illumination light beam in the first direction and the second illumination light beam are spatially coherent.

17. A defect inspection apparatus comprising:
a stage for moving a sample on which a pattern is formed;
a first illumination optical system which irradiates the sample with a first light beam;
a second illumination optical system which irradiates the sample with a second light beam, the polarization state of which differs from that of the first light beam;
a detection optical system which detects a light beam from the sample; and
a processing unit which uses the result of detection by the detection optical system to determine whether or not a defect exists in the sample, wherein:
the first projection of the illumination light beam in the first direction is substantially in parallel with the direction of the pattern, whereas the second projection of the second illumination light beam is substantially perpendicular to the direction of the pattern.

18. The defect inspection apparatus according to claim 17, wherein:
the first projection is perpendicular to the pattern pitch of the sample, whereas the second projection is in parallel with the pattern pitch of the sample.

19. (canceled)
